(19) United States
(12) Patent Application Publication
(10) Pub. No.: US 2005/0214061 A1
(43) Pub. Date: Sep. 29, 2005

(54) Writing instruments

(75) Inventor: Ronen Priewer, Central (HK)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Le Lumiere TM Ltd., Central (HK)

(21) Appl. No.: 10/975,985

(22) Filed: Oct. 29, 2004

(30) Foreign Application Priority Data
Mar. 24, 2004 (HK) 04102193.7

(51) Int. Cl. B43K 29/00

(52) U.S. Cl. 401/195

(57) ABSTRACT

This invention provides a writing instrument mounted with a gem, and having a loupe removably contained in the writing instrument. The user may use the loupe to view the gem relatively conveniently.

### FIELD OF THE INVENTION

This invention relates to writing instruments, particularly pens or the like.

### BACKGROUND OF THE INVENTION

Writing instruments decorated with gems, like a pen mounted with a piece of diamond, may act as luxury or collector items. Although gems may be appreciated with the normal eye, one who appreciates the finer qualities of a gem in terms of the color and may prefer to have a tool for viewing the gem, like a magnifying glass instrument. However, such a viewing tool may be relatively inconvenient to be carried separately.

### OBJECTS OF THE INVENTION

Therefore, it is an object of this invention to resolve at least one or more of the problems as set forth in the prior art. As a minimum, it is an object of this invention to provide the public with a useful choice.

### SUMMARY OF THE INVENTION

Accordingly, this invention provides a writing instrument having a first and a second portion, and a gem mounted on said writing instrument, and a loupe removably contained in the first portion.

Preferably, the gem is a piece of diamond. Optionally, the gem is mounted on the first portion. More preferably, the gem is mounted at one end of the first portion.

### BRIEF DESCRIPTION OF THE DRAWINGS

Preferred embodiments of the present invention will now be explained by way of example and with reference to the accompanying drawings in which:

FIG. 1 shows a writing instrument of this invention and its exploded views; and

FIG. 2 shows the views of a piece of diamond viewed by the loupe contained in the writing instrument of this invention.

### DETAILED DESCRIPTION OF THE PREFERRED EMBODIMENT

This invention is now described by way of example with reference to the figures in the following paragraphs. List 1 is a part list so that the reference numerals in the figures may be easily referred to.

Objects, features, and aspects of the present invention are disclosed in or are obvious from the following description. It is to be understood by one of ordinary skill in the art that the present discussion is a description of exemplary embodiments only, and is not intended as limiting the broader aspects of the present invention, which broader aspects are embodied in the exemplary constructions.

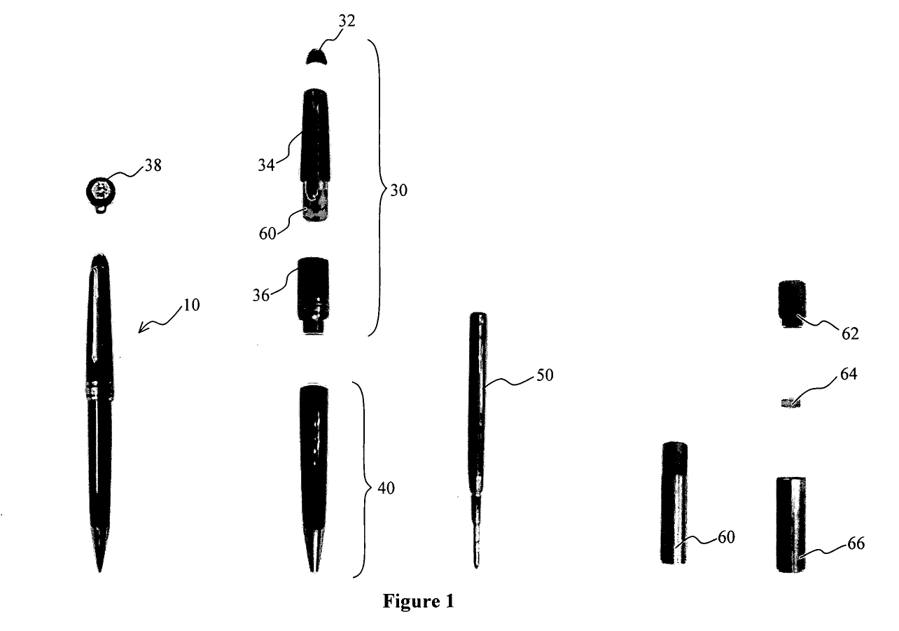

FIG. 1 shows the writing instrument 10 of this invention, and its components in its exploded view. The writing instrument 10 as shown in FIG. 1 is in the form of ball point pen, but of course other forms of writing instruments are possible, like a fountain pen or mechanical pencil.

The pen 10 may be divided a first portion 30 and a second portion 40. These portions generally are separable from each other but this is not a must for this invention. The second portion 40 may contain the filler 50 of the ball point pen. The first portion 30 may be further divided into three sections, a crown 32 at one end attached to a detachable upper barrel 34, which is in turn connected to a lower barrel 36. The viewing instrument or the loupe 60 is contained in the detachable upper barrel 34. However, the structure of the first portion 30 as shown in FIG. 1 is merely an example, and other configurations are possible. For example, the first portion 30 may be formed by only the crown 32 and the upper barrel 34 containing the viewing instrument 60, which may be directly connected with the second portion 40.

The gem 38 may be mounted on the crown 32 at one end of the first portion 30. It is possible to mount the gem 38 onto other portions of the writing instrument 10, for example, the body of the firs barrel 34.

The viewing instrument 60 as shown in FIG. 1 is a loupe particularly if the gem is a piece of diamond. Loupe is a simple brilliance assessment device with a magnifying lens, say 6.5× or 10×, which can offer a qualitative assessment of symmetry. The loupe 60 may comprise a semi-transparent loupe eye piece 62 to shield filter excess light, a loupe lens 64, and a loupe cylinder 66. The loupe 60 should of course be sized to be contained in the first portion 30. The viewing instrument 60 can also be used independently to view other gems.

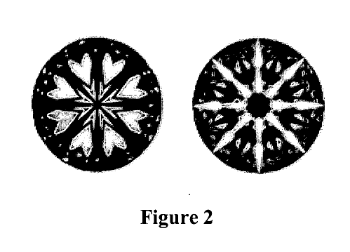

Some proportions of diamonds when cut with perfect symmetry display 8 hearts and 8 arrows, as shown in FIG. 2. A pleasing distribution of black gives an observer a nice display of scintillation as the stone is rocked from side to side. The 8 hearts pattern can viewed by the loupe from the pavilion side of the diamond while the 8 Arrows are visible using the loupe from the top of the Hearts and Arrows Diamond.

The writing instrument 10 of this invention may allow the user to have a handy and suitable tool for viewing the gem mounted on the writing instrument 10. The may enhance the value of the writing instrument 10.

While the preferred embodiment of the present invention has been described in detail by the examples, it is apparent that modifications and adaptations of the present invention will occur to those skilled in the art. Furthermore, the embodiments of the present invention shall not be interpreted to be restricted by the examples or figures only. It is to be expressly understood, however, that such modifications and adaptations are within the scope of the present invention, as set forth in the following claims. For instance, features illustrated or described as part of one embodiment can be used on another embodiment to yield a still further embodiment. Thus, it is intended that the present invention cover such modifications and variations as come within the scope of the claims and their equivalents.

1. A writing instrument having a first and a second portion, and a gem mounted on said writing instrument, characterized in that said writing instrument further including a loupe removably contained in the first portion.

2. The writing instrument of claim 1, characterized in that the gem is a piece of diamond.

3. The writing instrument of claim 1, characterized in that the gem is mounted on the first portion.

4. The writing instrument of claim 3, characterized in that the gem is mounted at one end of the first portion.
